(19) United States
(12) Patent Application Publication
(10) Pub. No.: US 2009/0003740 A1
(43) Pub. Date: Jan. 1, 2009

(54) Slide Bearing Material

(76) Inventors: Werner Schubert, Wiesloch (DE); Adam Strifler, St. Leon-Rot (DE); Wolfgang Bickle, Reilingen (DE)

Correspondence Address: DREISS, FUHLENDORF, STEIMLE & BECKER, POSTFACH 10 37 62, D-70032 STUTTGART, DE

(21) Appl. No.: 10/589,585

(22) PCT Filed: Feb. 21, 2005
(86) PCT No.: PCT/EP2005/001764

§ 371 Date: Sep. 16, 2008

(30) Foreign Application Priority Data
Feb. 21, 2004 (DE) 10 2004 008 631.1

(51) Int. Cl. F16C 17/00; B32B 5/16

(52) U.S. Cl. 384/129; 428/317.9

(57) ABSTRACT

The invention relates to a slide bearing material comprising a metallic supporting layer and a metallic lead-free porous carrier layer which is sintered on the supporting layer and used to receive a sliding layer material based on a polymer, said carrier layer consisting of a tin bronze with bismuth additives. The aim of the invention is to achieve a higher scoring resistance. To this end, the carrier layer consists of a sintering powder consisting of powder particles containing between 9.5 and 11 wt. % of tin and between 7 and 13 wt. % of bismuth and copper, and the powder particles have a bulbous shape deviating from the regular spherical shape but without edges and undercuts.

The invention concerns a slide bearing material with a metallic support layer and a metallic, lead-free, porous carrier layer sintered thereon, for receiving a slide bearing material based on a polymer, wherein the carrier layer is formed of tin bronze with bismuth additives.

Slide bearing materials and slide bearings produced therefrom are well known. Carrier layers of lead-containing tin bronze, e.g. CuSn10Pb10, in connection with a slide bearing material with PTFE as polymer basis have been conventionally used. However, the demand for lead-free bearing materials continues to increase.

WO 03/031102 A1 discloses e.g. a lead-free slide bearing material, wherein an initially porous sintered layer is completely compressed to form the sliding layer. This slide bearing material is therefore of a different type. The composition of the sliding layer material comprises 8 to 12 weight % of tin, 1 to less than 5 weight % of bismuth, 0.03 to 0.08 weight % of phosphorous, the rest being copper. According to the teaching of this document, the layer is produced from a mixture of different particles having different compositions, such that the portion of bismuth in the completely compressed state of the sliding layer does not exceed 5 weight % bismuth in order to avoid weakening of the sliding layer material matrix structure.

EP 0 687 740 B1 discloses a lead-free bearing metal which is cast as a monometal to form sliding elements. The main components of the lead-free composition are 4.85 to 9 weight % of tin and 3.81 to 9 weight % of bismuth, the rest being copper.

EP 0 224 619 B1 discloses a number of partially lead-free bearing metal alloys comprising between 0.5 and 4 weight % of tin, 10 to 20 weight % of bismuth and 0 to 1 weight % of lead etc., the rest being copper. The bearing alloy can be disposed onto a steel support layer through sintering, casting or rolling.

WO 03/013767 A1 discloses a solid material bearing, which does not have all of the features of the pre-characterizing part of claim 1, with wall thicknesses between 2 and 20 mm of sintered bronze filled with PTFE, wherein a relatively fine bronze powder is cold-pressed before sintering to form the final shape. The bronze powder may additionally contain up to 11 weight % of aluminium, iron, bismuth and/or lead.

It is the underlying purpose of the present invention to improve a slide bearing material of the above-mentioned type in order to increase its scoring resistance, so that it can be used at high sliding speeds.

This object is achieved in accordance with the invention with a slide bearing material of the above-mentioned type in that the carrier layer is formed from a sintering powder which consists of powder particles comprising 9.5 to 11 weight % of tin and 7 to 13 weight % of bismuth and copper, wherein the powder particles do not have a regular spherical shape but a bulbous shape without edges and undercuts.

In accordance with the invention, it has turned out that the high bismuth content provides the present slide bearing material with an excellent scoring resistance without reducing the carrying capacity thereof. If the porous carrier layer were produced from a regular spherical sintering powder, the sliding layer material could not be retained in the manner required. It has also turned out that only the bismuth additive of the claimed amount produces a lead-free bulbous sintering powder having a non-regular spherical shape without edges and undercuts, i.e. no “spattered” shape. This preferentially yields larger pore volumes compared to use of a sintering powder of mainly regular spherical shape, which has a positive effect on the retaining capacity of the polymeric sliding layer material on the carrier layer but is still accompanied by a high carrying capacity, i.e. load resistance. The claimed bulbous shape, which differs from the regular spherical shape, defines powder particles which are not spherical but which also do not have edges or undercuts, such as irregular, “spattered” powder particles which have solidified into bizarre structures. The claimed shape is substantially round, however, with a diameter ratio or length/width ratio of approximately 1.5 to 3. (An ideal spherical shape has a diameter ratio of 1). In practice, the majority of spherical powder particles are in a range between 1 and 1.1.

Bulbous powder particles having a bulk density of 4.3 to 5 are preferably used to produce the carrier layer. The bulk density of a specific powder material (bulk) for filling a predetermined volume with bulk powder is that factor which, when multiplied by the mass of water which would fill the same volume, yields the mass of the powder. Filling a volume of 100 cm³ with bulk powder yields a powder mass of 430 to 500 g. This bulk density value depends on the geometry of the powder of given alloy composition (and therefore given specific weight).

A pore volume of 30 to 40% is preferably used. The porosity of the porous carrier layer formed from sintered or sprayed metallic particles of irregular geometry can be calculated and stated in percent through determining the ratio between the surface portion of the pores and the overall cross-sectional surface of the porous carrier layer in a metallographic section. Towards this end, a metallographic section perpendicular to the belt plane can be produced from a slide bearing composite material after impregnation of the sliding layer material. The surface content of the bronze components shown in cross-section is then determined through scanning the periphery using a microscope. This surface content is subtracted from the overall cross-sectional surface of the carrier layer. The remaining surface then belongs to the pores and can be stated as porosity in a percentage portion relative to the overall surface. Evaluation of five different sections of the same slide bearing composite material with a separation of a few tenths of a millimeter produces sufficiently accurate values.

It has also turned out that it is essential to use only one single type of powder particles, i.e. only one composition, when the porous carrier layers are formed through point connection between the sintered powder particles, in order to achieve as homogeneous a solidity as possible within the carrier layer, which is mainly determined by the connecting regions between the powder particles.

The bulbous metallic powder particles which form the porous carrier layer preferably have a characteristic grain size of between 110 and 130 μm. The characteristic grain size is the value in μm, which is exceeded by 50 mass % of an observed bulk (with 50% falling below). It is therefore an average particle size. The grain size distribution for a given bulk is determined through screening refuse examination. The result can either be stated in mass % (not accumulated) for a respective mesh size or be accumulated according to DIN ISO 4497 (such that almost 100 mass % is determined for the smallest mesh size). The accumulated screening refuse can be expressed by a distribution function, i.e.

$$- {( \frac{t}{η} )}^{β}$$

R=e
R=accumulated screening refuse
t=mesh size
η=characteristic grain size
β=shape parameter (slope of the straight line with logarithmic plotting according to DIN 66 145).

A preferred grain size distribution is characterized by a shape parameter of 6 to 200 and a characteristic grain size in the above-stated range.

Preferred compositions of the powder particles can be extracted from the subsequent claims. The alloy consists, in particular, of the alloy components stated in the claims, optionally with impurity-related additives of an overall amount of less than 1 weight %.

A preferred alloy composition for the production of the powder particles which are used to form the carrier layer is a CuSn10Bi8 alloy.

In accordance with a preferred embodiment of the inventive slide bearing material, the sliding layer material comprises PTFE as a polymer basis. In this case, the carrying capacity of the bearing material is provided by the porous carrier layer of tin bronze, wherein the bulbous powder particles of this layer ensure high carrying capacity which is e.g. higher than in the layers formed from inconstant, irregular, “spattered” powder materials. The high bismuth portion of the claimed range supports the lubricating effect of the PTFE sliding layer material, thereby increasing the scoring resistance of the inventive slide bearing material.

In accordance with a further preferred embodiment of the inventive slide bearing material, the sliding layer material has PVDF and/or PEEK as a polymer basis. These two polymers can provide the slide bearing material with sufficient carrying capacity. In this case, the sintered tin bonze layer acts only as a bonding agent for the polymeric sliding layer material which largely accepts the carrying function of the bearing.

The sliding layer material may contain fillers. Feasible fillers are e.g. 5 to 12 vol. % of zinc sulphide or barium sulphate and/or 5 to 12 vol. % of graphite. 2 to 6 vol. % of carbon fibers can also be added.

1-11. (canceled)

12. A slide bearing composite material comprising:
a metallic support layer;
a sliding layer of polymer basis; and
a metallic, lead-free, porous carrier layer sintered on said support layer for receiving said sliding layer, said carrier layer formed from tin-bronze sintering powder particles consisting essentially of 9.5 to 11 weight % of tin, 7 to 13 weight % of bismuth, 0 to 4.0 weight % of zinc, the rest copper and impurities, wherein the powder particles have a bulbous shape deviating from a regular spherical shape, but without edges and undercuts and having a length/width ratio of approximately 1.5-3, said carrier layer having a pore volume of 28 to 45%.

13. The slide bearing composite material of claim 12, wherein said carrier layer has a pore volume of 30 to 40%.

14. The slide bearing composite material of claim 12, wherein a grain size distribution of said metallic particles has a characteristic grain size of 100 to 150 μm or of 110 to 130μm.

15. The slide bearing composite material of claim 12, wherein a grain size distribution of said metallic particles has a shape parameter β of 6 to 200.

16. The slide bearing composite material of claim 12, wherein said powder particles comprise 7 to 11 weight % of bismuth.

17. The slide bearing composite material of claim 16, wherein said powder particles comprise 7.5 to 10 weight % of bismuth.

18. The slide bearing composite material of claim 12, wherein said powder particles comprise 9.5 to 10.5 weight % of tin.

19. The slide bearing composite material of claim 12, said sliding layer comprising PTFE as said polymer basis.

20. The slide bearing composite material of claim 12, wherein said sliding layer comprises PVDF and/or PEEK as said polymer basis.

21. The slide bearing composite material of claim 12, wherein said sliding layer comprises additional fillers.

22. A slide bearing bushing produced from the slide bearing composite material of claim 12.
